(19) United States
(12) Patent Application Publication
(10) Pub. No.: US 2014/0284075 A1
(43) Pub. Date: Sep. 25, 2014

(54) THERMALLY CONDUCTIVE SELF-SUPPORTING SHEET

(71) Applicant: Merck Patent GmbH, Darmstadt (DE)

(72) Inventors: Ryuta Suzuki, Ken (JP); Matthias Kuntz, Seeheim-Jugenheim (DE); Reinhold Rueger, Roedermark (DE)

(73) Assignee: MERCK PATENT GMBH, Darmstadt (DE)

(21) Appl. No.: 14/350,815

(22) PCT Filed: Oct. 1, 2012
(86) PCT No.: PCT/EP2012/004113

§ 371 Date: Apr. 10, 2014

(30) Foreign Application Priority Data
Oct. 14, 2011 (EP) 11008292.2
Nov. 2, 2011 (EP) 11008729.3

(51) Int. Cl. H01B 3/10; C09K 5/14

(52) U.S. Cl. CPC H01B 3/10; C09K 5/14
USPC 174/110 R; 29/887; 252/74; 252/75; 252/76; 427/372.2

(57) ABSTRACT

The present invention relates to a thermally conductive, self-supporting, electrically insulating, flexible sheet, which is advantageously useful for the insulation of electrical machines or devices, to a process for the manufacture as well as to the use thereof.

The present invention relates to a thermally conductive, self-supporting, electrically insulating, flexible sheet, which is advantageously useful for the insulation of electrical machines or devices, in particular those where high voltages are used, to a process for the manufacture of such a thermally conductive flexible sheet, as well as to the use thereof.

Electrical machines and devices, in particular those where high voltages are used, such as electric cable bundles, conductors, coils, generators, rotors, stators, etc., need good insulation against corona discharges. Besides pure insulating polymers or polymers containing fillers, mica is often used as a matter of choice, frequently in the form of mica tapes, wherein ground mica particles are arranged as a film of overlapping particles and where the mica film is in most cases applied onto a carrier material, for example a woven glass fibre, and eventually covered by a protective layer. Flexible mica tapes of different composition are thus available in the market.

Mica tapes of the kind mentioned above exhibit a satisfactory protection against corona discharges because of the good dielectric characteristics of mica. Nevertheless, mica exhibits a poor thermal conductivity. Therefore, heat produced in the interior of the electrical machines and devices is not transferred to the surface of these machines and devices in case they are insulated with mica tapes or different mica containing products. In many applications, better thermal conductivity of electrical insulating coverings of the machines and devices would be of high advantage, since increased thermal conductivity would result in increased power ratings of the machines and devices and the commonly used air cooling of those machines would be more effective.

Therefore, there have been made many efforts to provide technical solutions in order to achieve good electrical insulation as well as good thermal conductivity for insulating coverings of electrical machines and devices in the last years.

In EP 266 602 A1, a coil for electrical machines is disclosed, wherein the coil is covered by some layers of an ordinary mica tape, followed by a layer of an impregnating resin containing particles of a high intrinsic thermal conductivity. These particles are randomly distributed within the resin material which covers the coil, after the latter has been wrapped with the mica tape. Although the mica tape is flexible and may be wrapped around the coil as appropriate, the following resin layer, once coated, is stiff and unflexible because of the hardening process which takes place in order to stabilize the resin material. Since the mica tape is still applied to the coil, the thermally conductivity of the coil in total is bad.

In DE 197 18 385 A1, coatings for metallic elements of electrical machines are described, wherein the coatings are thermally conductive lacquer coatings applied onto each single metallic element. The lacquer coatings contain small filler particles having a particle size of from 1 μm to 100 μm which are randomly distributed in the lacquer layer and lead to a thermal conductivity of the resulting coating of at least 0.4 W/mK. Similar to the resin layers described above, the lacquer coatings of DE 197 18 385 A1 are hardened layers which are durably applied onto the metallic parts and are not changeable after being applied, neither in their thickness nor composition nor shape. Furthermore, they may be applied only to easily coatable metallic elements of electrical machines, not to more complicated structures composed of several elements.

Attempts have also been made to adjust the properties of mica tapes so that a higher insulation resistance, mechanical stability and/or thermal conductivity, each in combination with a certain flexibility, is achieved.

To this end, in EP 406 477 A1 a reinforced mica paper is disclosed, where a base layer is made of mica which is then reinforced by a further layer on at least one surface thereof, the further layer containing a mixture obtained by mixing arbitrary amounts of silicone resin, aluminium hydroxide, aluminium silicate, potassium titanate and a soft mica powder. The insulation resistance of such a mica paper is increased in comparison to usual mica papers.

A highly heat conductive tape is disclosed in U.S. Pat. No. 7,425,366 B2. Here, the tape contains a mica containing layer and a lining material, and the mica containing layer contains scaly particles having a heat conductivity of 0.5 w/mK or higher, a size of 1 μm or smaller, and a binder. Although mica tapes of this kind are flexible similar to usual mica tapes, the thermal conductivity thereof is, although higher than in usual mica tapes, not sufficient in order to result in a higher energetic efficiency of the insulated electric machine or device. In addition, due to several layers in the mica tapes, the thickness thereof is relatively high, leading to limitations in flexibility and use.

It would be of high advantage, if an electrically insulating tape could be provided for insulation purposes, which exhibits sufficient insulation against corona discharge, a sufficient thermal conductivity for the heat transfer to the outside of the machine or device, thereby increasing the energy efficiency of the machine or device, which would exhibit a low thickness for good flexibility at a certain degree of mechanical stability as well as a sufficient tensile strength and which would not contain a high percentage of binders etc., the latter would diminish the thermal conductivity thereof. Furthermore, the insulating tape should, advantageously, not contain any mica.

Therefore, the object of the present invention is to provide an electrically insulating flexible sheet or tape having the properties described above.

In addition, a further object of the present invention is to provide a process for the manufacture of such a thermally conductive sheet.

Furthermore, it is another object of the present invention to provide useful applications for such a thermally conductive sheet.

The object of the present invention is solved by a thermally conductive, self-supporting, electrically insulating, flexible sheet, consisting of from 70.0 to 99.9% by weight of a particulate filler material having an intrinsic thermal conductivity of at least 5 W/mK and of from 0.1 to 30% by weight of a film forming organic compound.

Furthermore, the object of the present invention is also solved by a process for the production of a thermally conductive, self-supporting, electrically insulating, flexible sheet, wherein the following steps are carried out:
keeping an aqueous suspension of a particulate filler material having an intrinsic thermal conductivity of at least 5 W/mK under stirring,
surface treating the particulate filler material by adding an acid and/or a base,
adding to the suspension at most 30% by weight of a film forming organic compound solution or emulsion, based on the total solids content of the film forming organic compound and the particulate filler material,
applying the then resulting suspension onto a filter sheet, thereby resulting in a wet layer containing solid aggregates of the particulate filler material on the filter sheet,
optionally washing the resulting layer on the filter sheet, and
drying the resulting layer, whereby a solid flexible, self-supporting sheet is obtained.

In addition, the object of the present invention is solved by the use of a thermally conductive, flexible sheet as described above for the insulation of electrical machines or devices.

The thermally conductive, self-supporting, electrically insulating, flexible sheet according to the present invention consists of from 70.0 to 99.9% by weight, based on the sheet, of a particulate filler material having an intrinsic thermal conductivity of at least 5 W/mK and of from 0.1 to 30% by weight, based on the sheet, of a film forming organic compound.

The term self-supporting, although self-explanatory, in the sense of the present invention means that the sheet is mechanically stable by itself without the need of any support or covering layer.

The term flexible, although self-explanatory, in the sense of the present invention means that the sheet may be wound, wrapped or lapped around any device or item.

In a preferred embodiment of the present invention, the particulate filler material (filler particles) is present in an amount of from 85.0 to 99.5% by weight, based on the weight of the thermally conductive flexible sheet. Especially preferred is a filler content of from 95 to 99.5% by weight, most preferred a filler content of from 98 to 99.5% by weight.

Filler materials having an intrinsic thermal conductivity of at least 5 W/mK are known per se and have been used as fillers for thermally conductive coatings or resins already. Usually, when being particular, they exhibit rather small particle sizes of about 1 μm or smaller like in U.S. Pat. No. 7,425,366 B2, of from 0.1 to 15 μm as described in EP 266 602 A1, or of from 1 μm to 100 μm as disclosed in DE 197 18 385 A1. While the smaller particle ranges might be achieved by grounding appropriate starting materials, particles sizes of larger than 20 μm are seldom available in the market, at least not for each and any of the materials which would fulfil the intrinsic thermal conductivity requirement. In the case that these filler particles are randomly distributed in a coating or resin, smaller particle sizes are preferred in the art.

Filler particles which exhibit an intrinsic thermal conductivity of at least 5 W/mK according to the present invention are, for example, composed of at least one of aluminium oxide, boron nitride, boron carbide, diamond, carbon nitride, aluminium carbide, aluminium nitride, silicon oxide, silicon carbide, silicon nitride, magnesium oxide, zinc oxide or beryllium oxide. Mixtures of two or more of these are also possible.

Of these, filler particles of aluminium oxide are preferred. Aluminium oxide, according to the present invention, is preferably used as the main component of the filler material. This means that preferably more than 50% by weight, based on the weight of the filler, is of aluminium oxide, i.e. of aluminium oxide filler particles. The aluminium oxide filler particles may also be used in combination (e.g. mixture) with filler particles made of one or more compounds, chosen from the compounds mentioned above. Preferred is the embodiment of the invention wherein all of the filler, i.e. all of the filler particles, is of aluminium oxide.

In addition, the aluminium oxide for the aluminium oxide filler particles may also be doped with a minor amount of titanium dioxide. About 0.1 to 5% by weight, based on the total weight of aluminium oxide and titanium oxide, may be of titanium dioxide. Aluminium oxide filler particles containing such a minor amount of titanium oxide will be referred to as aluminium oxide filler particles in the following too, like pure aluminium oxide filler particles. Indeed, aluminium oxide filler particles containing such minor amounts of titanium oxide are especially preferred according to the present invention.

Binder materials diminish the thermally conductivity of a coating, layer or sheet, which contain thermally conductive particles and binder. Therefore, it is highly desirable to make available a flexible sheet or tape which contains a minimum of binder and a maximum of thermally conductive filler particles. Unfortunately, small filler particles request a certain amount of a binder material in order to be able to form a flexible sheet or tape. It is common practice to use a maximum filler content of from 55 to 65% by weight, based on the insulation material, in electrically insulation materials, whether they are thermally conductive or not (see Andreas Küchler “Hochspannungstechnik”, Springer Verlag, 3. Auflage 2009, S. 303), since, otherwise, the wetting and inclusion of the filler particles in the binder matrix would not be sufficient. Merely mica constitutes an exception, since mica particles may be formed into sheets by using none or almost none binder materials, due to the binding forces which are present between the mica particles.

For flexible, self-supporting, thermally conductive sheets or tapes which are in their construction similar to mica tapes, the small filler particles exhibiting an intrinsic thermal conductivity of at least 5 W/mK of the prior art, which are disclosed above, do not seem to be useful, since they needed to form a sheet or tape by using merely small amounts of binder, which requirement seems to be a contradiction per se due to the wetting behavior of small filler particles in binders as described above.

Surprisingly, it has now been found that small filler particles exhibiting an intrinsic thermal conductivity of at least 5 W/mK as disclosed above may be used for the production of flexible, self-supporting thermally conductive sheets, provided that the surface of the small filler particles is treated in such a way that the filler particles exhibiting small primary particle size may stick together to form agglomerates having large particle sizes of about 150 μm or even larger. Agglomerates of such big sizes need merely very small amounts of binder in order to form flexible sheets thereof.

Thus, the primary particle size of the particulate filler (filler particles) according to the present invention is merely in the range of from 5 to 60 μm. The primary particles usually exhibit a particle size distribution D₅₀ in the range of from 10 to 40 μm.

The filler particles exhibit an intrinsic thermal conductivity of at least 5 W/mK and are composed of at least one of aluminium oxide, boron nitride, boron carbide, diamond, carbon nitride, aluminium carbide, aluminium nitride, silicon oxide, silicon carbide, silicon nitride, magnesium oxide, zinc oxide, beryllium oxide or mixtures thereof. Alternatively, mixtures of filler particles being composed of the materials mentioned above might be used. Aluminium oxide is preferred, either in an amount of more than 50% by weight, based on the filler, or, mostly preferred, as single filler material, (including the titanium dioxide doped aluminium oxide particles as described above).

It is preferred, that the primary filler particles exhibit a platelet shaped form, which means that they exhibit a platy, flat structure and an aspect ratio [ratio of mean longest axis (length or width) to mean shortest axis (thickness) of the particles] of at least 20, preferably of at least 50, and most preferred of at least 80. The platelet shaped form of the primary filler particles allows slight overlaps of the single particles in the resulting aggregates and good orientation of the primary filler particles as well as of the aggregates along the largest surfaces of the flexible sheet which is formed.

Platelet shaped primary filler particles of aluminium oxide who's particle size and aspect ratio is within the ranges described above can be prepared according to the patent mentioned below. Preferred are aluminium oxide platelets, which are usually used as substrates for the production of effect pigments such as interference pigments (e.g. interference pigments which are traded under the name Xirallic® by Merck KGaA, Darmstadt, Germany). Platelet shaped aluminium oxide pigments of this type may be produced by particular crystallization processes leading to single crystals and may contain a minor amount (up to about 5% by weight) of foreign metal oxides such as titanium dioxide. They may be produced in a process similar to the substrate forming steps as described in EP 763573 B1, by varying the amount of titanium dioxide within the limits given in the a.m. patent, by varying the temperature of the final heat treatment and the time for crystallization growth in order to achieve at the right particle size and aspect ratio.

In a similar process, pure aluminium oxide primary filler particles may also be produced simply by omitting the titanium dioxide. For the purpose of the present invention, the platy shape, the size and the thickness of those aluminium oxide primary particles would be of sufficient quality. Nevertheless, primary aluminium oxide filler particles containing minor amounts of titanium dioxide as described above are preferred.

Primary platelet shaped filler particles having a particle size within the size range mentioned above, namely having a particle size in the range of 5-60 μm, made of boron nitride, boron carbide, diamond, carbon nitride, aluminium carbide, aluminium nitride, silicon oxide, silicon carbide, silicon nitride, magnesium oxide, zinc oxide, beryllium oxide or mixtures thereof, are available in the market.

After surface treatment of the filler particles, they are able to form aggregates containing the primary platy particles having a primary particle size in the range of from 5 to 60 μm. The aggregates, when produced as described later, exhibit a large lateral dimension and a small thickness, which is in the range of several layers of filler particles only.

According to the present invention, the lateral dimension of the aggregates formed of the primary filler particles depends on the method and kind of surface treatment of the primary filler particles. A particle size distribution of the resulting aggregates which exhibits a D₅₀ value of at least 20 μm, in particular of at least 30 μm, may be sufficient in order to produce the flexible thermally conductive sheet of the present invention.

Nevertheless, a particle size distribution of the resulting aggregates which exhibits a D₅₀ value of at least 50 μm, and may in particular be as high as having a D₅₀ value of at least 80 μm, preferably of at least 95 μm, is of greater advantage, since it facilitates the production process according to the present invention.

Depending on the surface treatment of the primary filler particles, the total particle size of the aggregates made of the primary filler particles may range up to 150 μm and, in particular, up to 200 μm. Primary filler particles of this size having a high thermal conductivity, in particular of the materials mentioned above, are not available in the market. Especially, primary platelet shaped aluminium oxide particles of this size are not available in the market.

The surface treatment of the primary filler particles is a treatment by applying to the filler particles an acid and/or a base.

Advantageously, the particular treatments are carried out in an aqueous or different liquid suspension of the primary filler particles.

According to the present invention, a treatment with an acid and/or base, and, in particular a treatment with an acid, thereby adjusting the pH of the suspension of the primary filler particles at a strong acid range, namely from pH 0.5 to pH 3.0, followed by a treatment with a base, is preferred.

The treatment with an acid and a base according to the present invention is carried out in two steps. At first, a strong acid such as HCl, H₂SO₄ or HNO₃ in an appropriate amount and concentration is added to an aqueous suspension of the primary filler particles having an intrinsic thermal conductivity of at least 5 W/mK in order to adjust the pH in a range of from about 0.5 to 3.0, which is kept for a while and then eventually followed by addition of a strong base such as NaOH, KOH or NH₄OH in an appropriate amount and concentration in order to slightly raise the pH to a range of from 1.0 up to 6.0, preferably in a range of from 2.0 to 4.0.

After the first surface treatment of the primary filler particles, in particular the acid plus base treatment as described above, agglomeration of the primary filler particles starts, leading to particles sizes of the then obtained agglomerates (called first step agglomerates in the following) of about twice the primary particle size and corresponding higher D₅₀ values of the agglomerates.

Further agglomeration of the primary filler particles may be achieved by applying a second surface treatment to the then obtained first step agglomerates. To this end, a solution or emulsion, as the case may be, of the binder material is added to the suspension of the first step agglomerates. Since the surface of the primary particles has been pretreated as described above in order to be able to form the first step agglomerates and since these first step agglomerates do still exhibit reactive outer surfaces with a tendency to agglomerate, the addition of the binder at an early stage after the formation of the first step agglomerates leads to the formation of further, second step agglomerates which are bigger in size than the first step agglomerates. These second step agglomerates, who's particle sizes may be up to 200 μm as described above and who's particle size distribution D₅₀ may be in the range of 50 μm or higher, need merely a further slight amount of a binder in order to stick together to form a flexible, self supporting sheet in the end.

Advantageously, the binder used for the second step of agglomeration of the primary filler particles would be the same binder which is also used for the formation of the flexible sheet in the end. Therefore, merley one single addition step of a binder material, advantageously shortly after the first surface treatment for starting the agglomeration has taken place, will be sufficient for the formation of the flexible, self-supporting thermally conductive sheet of the present invention.

Useful binder materials are those which may act as film forming organic compound (which form continuous films of the binder material at least between the agglomerates of the primary filler particles which are obtained after the agglomerate formation step(s) and, to some extent, also on the upper and lower surface of the agglomerates, the latter films do not need to be continuous) according to the present invention. Thus, the binder or film forming organic compound is at least one of a monomer, oligomer or polymer having acrylic, silane, urethane, epoxy, amide, vinyl-chloride or phenyl groups in the molecule, which may optionally be fluorinated, or is a polyolefine, a polyester, or a mixed polymerized form of at least two thereof.

Preferred are binders or resins of the acryl copolymer type, styrene-acryl-type, polyester type, polyurethane type, polyolefin type, vinyl acetate type, vinyl acetate copolymer type, polystyrene type, polyvinylchloride type, polyvinylidene chloride copolymer type, polyvinyl chloride copolymer type or synthetic rubber type.

In particular preferred are aqueous emulsion resins of the latex type or synthetic rubbers. Examples are styrene butadiene latex, acrylonitrile butadiene latex, vinyl acetate-ethylene latex, vinyl acetate-ethylene-vinyl chloride latex, styrene butadiene rubber or nitrile butadiene rubber.

In accordance to the present invention, the amount of the film forming organic compound which constitutes at the same time the binder material in the thermally conductive sheet is from 0.1 to 30% by weight, based on the weight of the conductive sheet. Preferably, the amount of the film forming organic compound is from 0.5 to 15% by weight, in particular from 0.5 to 5%, most preferred of from 0.5 to 2% by weight, based on the weight of the thermally conductive sheet.

It goes without saying that the amount of particulate filler material and film forming organic compounds in total, based on the solids content thereof, add to 100% by weight, based on the weight of the flexible thermally conductive sheet of the present invention.

Besides the film forming organic material, which does also constitute a binder material, the addition of a polymerization initiator subsequently or at the same time as the film forming organic material might be appropriate, whenever the film forming material is a monomer compound or oligomer compound or contains monomeric or oligomeric compounds. In addition, also in case the film forming material is already a polymeric material, the addition of a polymerization intitiator might be of advantage in order to enhance crosslinking. As polymerization initiators, usually used compounds for this purpose might be used, e.g. azo compounds, organic peroxides, anionic or cationic polymerization initiators. The particular compounds are known to the expert and do not need to be described further here.

If present, the polymerization initiator is present in an amount of from 0.001 to 10% by weight, based on the weight of the organic film forming compound in the thermally conductive sheet according to the invention. In the event that a polymerization initiator is present in addition to the particulate filler material and the film forming organic compound, the amounts of the three compounds add to 100%, based on the weight of the flexible thermally conductive sheet according to the present invention.

The thermally conductive, self-supporting, electriclally insulating, flexible sheet of the present invention has a thickness in the range of from 0.01 to 5.0 mm which may be varied according to the production process as described below. The thickness of the sheet may be measured by any instrument being able to measure length in the range of micrometers.

If appropriate, although the thermally conductive sheet according to the present invention is self-supporting by nature as well as flexible, the sheet may be mechanically strengthened by a substrate layer which may be in the form a polymer film, a sheet of glass fibers or similar substrates which are commonly used in the art. Even ordinary mica tapes may be used as a substrate to which the present flexible sheet may be attached, e.g. by an adhesive layer. The same holds true for the presence of a covering layer, which may be applied to the sheet according to the present invention, in particular as a protective sheet. These substrates and covering sheets may be of advantage in particular uses and may be applied to the thermally conductive sheet of the present invention either alternatively or in combination of both of them.

For the purpose of the present invention, the particle size is regarded as being the length of the longest axis of the primary pigment particles and of the pigment aggregates, respectively. The particle size of the primary pigment particles or of the pigment agglomerates can in principle be determined using any method for particle-size determination that is familiar to the person skilled in the art. The particle-size determination can be carried out in a simple manner, depending on the size of the primary pigments or pigment agglomerates, for example by direct observation and measurement of a number of individual particles or agglomerates in high-resolution light microscopes, such as the scanning electron microscope (SEM) or the high-resolution electron microscope (HRTEM), but also in the atomic force microscope (AFM), the latter in each case with appropriate image analysis software. The determination of the particle size can advantageously also be carried out using measuring instruments (for example Malvern Mastersizer 2000, APA200, Malvern Instruments Ltd., UK), which operate on the principle of laser diffraction. Using these measuring instruments, both the particle size and also the particle-size distribution in the volume can be determined from a pigment suspension in a standard method (SOP). The last-mentioned measurement method is preferred in accordance with the present invention.

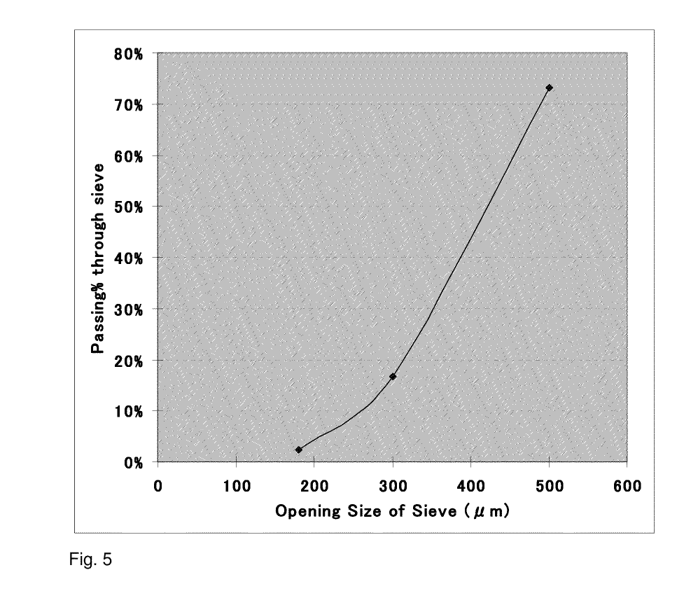

Furthermore, the approximate size of the agglomerates which, eventually, constitute the largest part of the flexible sheet according to the present invention, may also be determined by a sieve leaking test which is executed with different sieves exhibiting different pore sizes, whereby the percentage of agglomerates passing the sieves may be determined, as may be taken from FIG. 5.

The object of the present invention is also achieved by a process for the production of a thermally conductive, self-supporting, electrically insulating, flexible sheet as described above, comprising the following steps:
keeping an aqueous suspension of a particulate filler material having an intrinsic thermal conductivity of at least 5 W/mK under stirring,
surface treating the particulate filler material by adding an acid and/or base,
adding to the suspension at most 30% by weight of a film forming organic compound solution or emulsion, based on the total solids content of the film forming organic compound and the particulate filler material,
applying the then resulting suspension onto a filter sheet, thereby resulting in a wet layer containing solid aggregates of the particular filler material on the filter sheet,
optionally washing the resulting layer on the filter sheet, and
drying the resulting layer, whereby a solid, flexible, self-supporting sheet is obtained.

The first surface treatment of the particulate filler material is, according to the present invention, a treatment by adding an acid and/or a base, and in particular a treatment by adding an acid and a base. As already described earlier, the treatment with acid and base is advantageously performed in two steps, namely in the first step by adding a strong acid in order to achieve at a strong acidic pH, and in the second step by adding a strong base, thereby slightly raising the pH, but still maintaining an acidic pH range.

By the first surface treatment of the particulate filler material, the surface of the primary filler particles is activated in a way as to achieve at a strong tendency to agglomerate, leading to the first agglomeration of the primary filler particles as already described above.

The particulate filler material which is used in the present process is composed of filler particles which exhibit an intrinsic thermal conductivity of at least 5 W/mK, which are chosen from at least one of aluminium oxide, boron nitride, boron carbide, diamond, carbon nitride, aluminium carbide, aluminium nitride, silicon oxide, silicon carbide, silicon nitride, magnesium oxide, zinc oxide, beryllium oxide, or mixtures thereof. Aluminium oxide is preferred, either in an amount of more than 50% by weight, based on the particulate filler material, or, mostly preferred, as single filler material.

The amount, shape, structure, aspect ratio, size and particle size distribution as well as the corresponding production processes and other conditions of the applied filler particles and of the first agglomerates resulting from the first surface treatment are the same as already described earlier with respect to the flexible thermally conductive sheet of the present invention per se.

The second treatment for enhancing the agglomeration tendency of the primary filler particles as well as of the first agglomerates derived therefrom is carried out by adding the film forming organic compound which, at the same time, constitutes the binder in the thermally conductive sheet according to the present invention.

The film forming organic compound according to the present invention is at least one of a monomer, oligomer or polymer having acrylic, silane, urethane, epoxy, amide, vinyl-chloride or phenyl groups in the molecule, which may optionally be fluorinated, or is a polyolefine, a polyester, or a mixed polymerized form of at least two thereof.

Preferred are film forming organic materials of the acryl copolymer type, styrene-acryl-type, polyester type, polyurethane type, polyolefin type, vinyl acetate type, vinyl acetate copolymer type, polystyrene type, polyvinylchloride type, polyvinylidene chloride copolymer type, polyvinyl chloride copolymer type or synthetic rubber type.

The are in particular used as a solution or emulsion in the present process, as the case may be. Preferred are aqueous solutions or emulsions.

In particular preferred are aqueous emulsion resins of the latex type or synthetic rubbers. Examples are styrene butadiene latex, acrylonitrile butadiene latex, vinyl acetate-ethylene latex, vinyl acetate-ethylene-vinyl chloride latex, styrene butadiene rubber or nitrile butadiene rubber.

In accordance to the present invention, the amount of the film forming organic compound in the thermally conductive sheet is from 0.1 to 30% by weight, based on the weight of the present thermally conductive sheet, and, preferably, from 0.5 to 15% by weight, or, in particular from 0.5 to 5% by weight. The amount of the film forming organic compound which is used in the process for the production of the thermally conductive sheet of the present invention is merely slightly larger then the remaining film forming organic compound in the sheet and is used in the weight ranges as described above.

Since a low content of organic compounds (binder) in the thermally conductive sheet according to the present invention is of advantage, the amount of the film forming organic compound in the present process should be chosen as low as possible.

In addition, as already described above, the addition of a polymerizing initiator may be of advantage. If present, the amount of the polymerization initiator is from 0.001 to 10% by weight, based on the weight of the organic film forming compound in the thermally conductive sheet.

All components of the flexible thermally conductive sheet according to the present invention, namely either the particulate filler and the film forming organic compound, or, in the event that a polymerization initiator is additionally present, the particulate filler, the film forming organic compound and the polymerization initiator, based on the total solids thereof, add to 100% by weight, based on the weight of the flexible thermally conductive sheet.

The drying conditions may be chosen as appropriate and are preferable in a temperature range between 30° C. and 90° C. and in a time frame of from some minutes to some hours, depending on the particular substances and conditions. A shorter drying time is of economic advantage. As well, the drying temperature should be chosen as low as possible in order to avoid the formation of micro cavities in the resulting flexible sheet.

Furthermore, the object of the present invention is solved by the use of the thermally conductive, self-supporting, electrical insulating, flexible sheet according to the present invention for the insulation of machines and devices, in particular for the insulation for machines and devices in electrical facilities such as electric cable bundles, conductors, coils, generators, rotors, stators, etc.

Machines and devices using or generating high voltages are subject to exhibit corona discharges if not insulated good enough. Therefore, in order to avoid such corona discharges and in order to allow a good cooling behaviour and, combined therewith, increased power ratings, of such facilities, the thermally conductive and, at the same time, electrical insulating sheet of the present invention may be advantageously used for such purposes. The sheets according o the present invention are self-supporting, but for some purposes the application thereof to a mechanically strengthening substrate and/or the coating with a covering layer could be of advantage. In their dielectrical behavior, their flexibility and their mechanical stability, in particular their tensile strength in order to be rolled up in a web like form, the sheets (or tapes) according to the present invention are similar to usual mica tapes. It is, for example, possible to wind the sheets according to the present invention around a cylinder having a diameter of about 30 cm without being mechanically destroyed. Even better, the present flexible sheets are flexible enough to be wound around a cylinder having a diameter of about 10 cm, preferably of about 1 cm, without being mechanically destroyed. They may be used as versatile as mica tapes, since the insulation made therewith may be lapped or wrapped around a device or facility which exhibit any form or size. Contrary to mica tapes, they exhibit a high thermal conductivity which is due to the fact that they are composed to a high extent, preferably to more than 90% by weight, of materials having a high intrinsic thermal conductivity per se. Therefore, they may be advantageously used instead of mica tapes for insulation purposes when a high thermal conductivity of the insulation material is appropriate.

The present invention shall be explained to some detail by the following examples, but shall not be limited to these examples.

### EXAMPLE 1

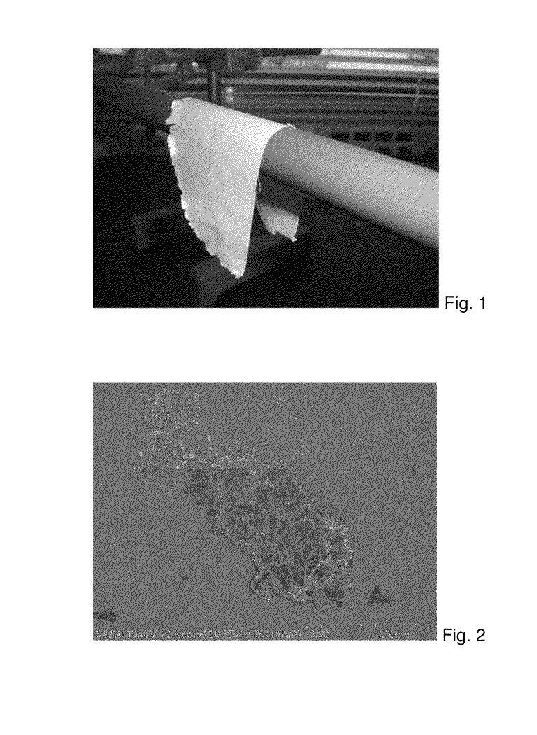

130 g of alumina flake particles (D₅₀=18 μm) is dispersed in deionized water to result in a dispersion of 2600 ml volume. The dispersion is adjusted to 45° C. under stirring. The pH is adjusted at pH=1.0 by adding 32% HCl. The resulting dispersion is kept under these conditions for about 30 minutes. In order to raise the pH to 2.0, 32% NaOH is added, followed by the addition of 130 g of a 1% solution of AE610H (carboxyl modified acrylic compound, product of Emulsion Technology Co., Ltd., Japan). The resulting dispersion is kept under stirring for about 10 minutes. Then, 40 g of the dispersion is poured onto a filter sheet having a pore size of about 100 μm and a diameter of 12.5 cm. The wet layer on the filter sheet is washed with deionized water twice. The remaining wet layer on the filter sheet is dried at a temperature of about 80° C. for 3 hours, upon which process a flexible, white alumina sheet is formed. The sheet is shown in FIG. 1. The SEM picture of the alumina flakes agglomerates formed is shown in FIG. 2.

### EXAMPLE 2

Example 1 is repeated, except that 130 g of a 1% emulsion of LX874 (acrylonitrile butadiene latex, product of Nihon Zeon Corp., Japan) is added instead of AE610H.

A similar flexible sheet of alumina as in example 1 is obtained.

### COMPARATIVE EXAMPLE 1

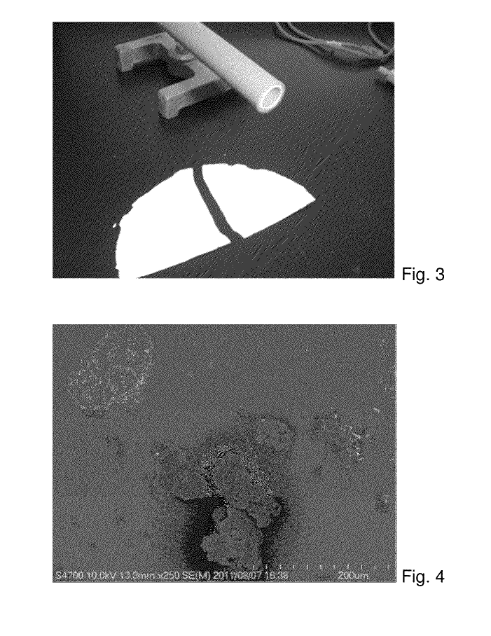

Example 1 is repeated, except that no organic film former is added to the alumina particle dispersion. The resulting alumina sheet is shown in FIG. 3. It may be taken therefrom that the alumina sheet of comparative example 1 does not exhibit a tension strength high enough to be wrapped around a stick. The sheet formed by the comparative process exhibits a minor flexibility and mechanical strength than the sheet according to the invention.

A SEM picture of the corresponding alumina agglomerates is shown in FIG. 4.

The particle size distribution (PSD) of the primary alumina particles used in example 1 as well as of the resulting agglomerates, measured by Malvern Mastersizer 2000, is shown in Table 1.

TABLE 1

| | PSD (μm) | | |
|---|---|---|---|
| | D₅ | D₅₀ | D₉₅ |
| Alumina flake | 6.7 | 17.9 | 36.1 |
| HCl/NaOH/organic | 18.6 | 95.7 | 196.9 |
| film former | | | |

A sieve leaking test of the agglomerates obtained in example 1 is carried out by using sieves of different pore sizes for the filtration of a dispersion of the alumina agglomerates of example 1. The passage of the alumina agglomerates is shown in FIG. 5.

1. Thermally conductive, self-supporting, electrically insulating, flexible sheet, consisting of from 70.0 to 99.9% by weight of a particulate filler material having an intrinsic thermal conductivity of at least 5 W/mK and of from 0.1 to 30% by weight of a film forming organic compound.

2. Thermally conductive flexible sheet according to claim 1, wherein
the particulate filler material is present in an amount of from 85.0 to 99.5% by weight.

3. Thermally conductive flexible sheet according to claim 1, wherein the particulate filler material is composed of at least one of aluminium oxide, boron nitride, boron carbide, diamond, carbon nitride, aluminium carbide, aluminium nitride, silicon carbide, silicon nitride, magnesium oxide or beryllium oxide.

4. Thermally conductive flexible sheet according to claim 1, wherein more than 50% by weight, based on the particulate filler material, is of aluminium oxide.

5. Thermally conductive flexible sheet according to claim 1, wherein all of the particulate filler material is of aluminium oxide.

6. Thermally conductive flexible sheet according to claim 1, wherein the particulate filler material is present in the form of aggregates which contain primary platy particles having a primary particle size in the range of from 5 to 60 μm.

7. Thermally conductive sheet according to claim 6, wherein the primary platy particles exhibit an aspect ratio of at least 20.

8. Thermally conductive flexible sheet according to claim 1, wherein the film forming organic compound is at least one of a monomer, oligomer or polymer having acrylic, silane, urethane, epoxy, amide, vinyl-chloride or phenol groups in the molecule, which may optionally be fluorinated, or is a polyolefine, a polyester, or is a mixed polymerized form of at least two thereof.

9. Thermally conductive flexible sheet according to claim 1, wherein a polymerization initiator is additionally present.

10. Process for the production of a thermally conductive, self-supporting, electrically insulating, flexible sheet according to claim 1, comprising the following steps:
a) keeping an aqueous suspension of a particulate filler material having an intrinsic thermal conductivity of at least 5 W/mK under stirring,
b) surface treating the particulate filler material by adding an acid and/or a base,
c) adding to the suspension at most 30% by weight of a film forming organic compound solution or emulsion, based on the total solids content of the film forming organic compound and the particulate filler material,
d) applying the then resulting suspension onto a filter sheet, thereby resulting in a wet layer containing solid aggregates of the particulate filler material on the filter sheet,
e) optionally washing the resulting layer on the filter sheet, and
f) drying the resulting layer, whereby a solid flexible, self-supporting sheet is obtained.

11. Process according to claim 10, wherein the surface of the particulate filler material is treated by adding an acid and a base.

12. Process according to claim 10, wherein the particulate filler material is composed of at least one of aluminium oxide, boron nitride, boron carbide, diamond, carbon nitride, aluminium carbide, aluminium nitride, silicon carbide, silicon nitride, magnesium oxide or beryllium oxide.

13. Process according to claim 10, wherein the film forming organic compound is at least one of a monomer, oligomer or polymer having acrylic, silane, urethane, epoxy, amide, vinyl-chloride or phenol groups in the molecule, which may optionally be fluorinated, or is a polyolefine, a polyester, or is a mixed polymerized form of at least two thereof.

14. Process according to claim 10, wherein a polymerization initiator is additionally added in step c).

15. A method of insulating a machine or device comprising insulating said machine or device with a thermally conductive, self-supporting, electrically insulating, flexible sheet according to claim 1.

16. A method according to claim 15, wherein the machine or device is an
electric cable bundle, a conductor, a coil, a generator, a rotor or a stator.

17. An electric cable bundle, conductor, coil, generator, rotor or stator, provided with a thermally conductive, flexible sheet according to claim 1.
